(19) United States
(12) Patent Application Publication
(10) Pub. No.: US 2023/0161294 A1
(43) Pub. Date: May 25, 2023

(54) WATCH CASE COMPRISING AN EXTERNAL PART COMPONENT WHEREON A STACK OF THIN LAYERS IS DEPOSITED

(71) Applicant: The Swatch Group Research and Development Ltd, Marin (CH)

(72) Inventors: Loïc CURCHOD, Lausanne (CH); Michel SAGRDOYBURU, Neuchâtel (CH); Simon SPRINGER, Berne (CH)

(73) Assignee: The Swatch Group Research and Development Ltd, Marin (CH)

(21) Appl. No.: 17/940,470

(22) Filed: Sep. 8, 2022

(30) Foreign Application Priority Data
Nov. 23, 2021 (EP) 21209841.2

(51) Int. Cl. G04B 45/00; G04B 37/22

(52) U.S. Cl. CPC G04B 45/0015; G04B 37/223

(57) ABSTRACT

A watch case (10) including a middle (11) to which a crystal (12) and a back (13) are fastened so as to form an internal volume, the watch case (10) including, in the internal volume, an external part component (14) whereon a stack of thin layers (15) comprising a substrate layer (150), a solid-state phase switching layer (151) inserted between a transparent encapsulation layer (152) and a spacing layer (153) separating the phase switching layer (151) from the substrate layer (150) is deposited, the phase switching layer (151) being configured so as to have a refractive index capable of varying under exposure from light rays so as to impart to the stack of thin layers (15) at least two interferential colours.

### CROSS REFERENCE TO RELATED APPLICATIONS

This application is claiming priority based on European Patent Application No. 21209841.2 filed on Nov. 23, 2021, the disclosure of which is incorporated herein in its entirely by reference.

### TECHNICAL FIELD OF THE INVENTION

The invention relates to the field of watchmaking, and relates more particularly to a watch case including an external part component whereon a stack of thin layers is deposited.

### TECHNOLOGICAL BACKGROUND

Thin layers are commonly used in the field of watchmaking to modify the surface properties of horological components. They are particularly used for decorative purposes.

Several methods can be used to deposit thin layers: physical vapour deposition, known as the acronym “PVD, chemical vapour deposition, known as the acronym “CVD”, atomic layer deposition, known as the acronym “ALD”, or galvanic growth.

The thin layers can be made from pure metals, from metal alloys, or from ceramic materials.

Nevertheless, these thin layers offer a relatively limited range of intrinsic colours according to the composition thereof and thickness thereof. Moreover, these layers are more or less translucent according to the composition thereof and the thickness thereof, and the colour thereof is somewhat unsaturated.

A larger range of colours and more saturated colours can be obtained thanks to the interferential colours obtained by stacking different thin layers, typically made of semi-transparent dielectric material, deposited on a reflective layer formed by a metallic mirror.

Nevertheless, the colour of these stacks is closely dependent on the optical thickness of the thin layers, which is typically of the order of a quarter of the wavelengths of the visible range, which requires precise control of the deposition thickness and limits the application thereof to substrates in planar form, i.e. in two dimensions. In addition, the colour of these thin layers perceived by a user varies considerably according to the viewing angle thereof as the length of the optical path changes, which represents a major drawback for some aesthetic applications.

All the thin layers cited above are monochrome and a multicoloured decoration requires as many deposition steps as desired colours, said deposition steps being followed by intermediate structuring steps typically performed by means of photolithography and chemical etching, so-called “lift-off”, “shadow mask”, or laser ablation process.

These structuring steps often prove to be laborious and expensive in order to observe tolerance requirements. Moreover, they are soiling, particularly in that they use chemical baths or they produce gases, dust and other residues. The structuring steps are therefore followed by a washing step before the assembly, in the watch, of the component produced.

There is, consequently, a need to provide a component having bright and saturated colours over a wide range of colours, wherein the appearance has little or no dependence on the viewing angle on the component, and wherein the structuring of these colours is not soiling or liable to release gases, dust or other residues.

### SUMMARY OF THE INVENTION

The present invention relates to a watch case comprising a middle to which a crystal and a back are fastened so as to form an internal volume, said case including, in said internal volume, an external part component whereon a stack of thin layers is deposited.

The stack of thin layers comprises a substrate layer, a solid-state phase switching layer inserted between a transparent encapsulation layer and a spacing layer separating said phase switching layer from the substrate layer.

Thanks to the specific arrangement of the stack of thin layers, the external part component has optical properties producing interferential colours.

Herein, “interferential colour” refers to a colour generated by an optical interference phenomenon.

The phase switching layer is configured so as to exhibit a crystallographic phase change by a thermal effect, particularly under exposure from locally absorbed light rays. The crystallographic phase change involves a change of the refractive index thereof so as to impart to the stack of thin layers at least two different interferential colours between the zones exposed to light rays and the zones not exposed to light rays.

Thus, a wide range of saturated and intense colours can be generated, particularly by varying the thicknesses of the phase switching layer and the spacing layer, and a multicoloured decoration of the external part component can be obtained.

It is worth noting that the light rays pass through the crystal or the back if the latter includes a crystal, and depending on where the external part component is disposed.

As phase switching does not produce any gas, solid or liquid emissions, producing the at least two interferential colours, and hence decorating the external part component, requires no subsequent cleaning operation.

Thus, it is possible to decorate the external part component at the end of production of the watch case, when selling the watch case, or in an after-sales period. This aspect allows any customisation of the decoration of the external part component.

In specific embodiments, the invention can further include one or more of the following features, taken in isolation or according to any technically possible combinations.

In specific embodiments, the phase switching layer is configured to have two reversibly switchable phase states, said phase states being a crystalline phase and an amorphous phase.

The decoration of the external part component is thus reversible.

In specific embodiments, the encapsulation layer is transparent at the wavelength of the light rays under the exposure whereof the refractive index of the phase switching layer is capable of varying.

In specific embodiments, the substrate layer is made of a transparent or translucent material.

In specific embodiments, the stack of thin layers is deposited on a support formed by all or part of the external part component, the substrate layer or the encapsulation layer being formed by the support.

In specific embodiments, the external part component is a dial, a structure of a horological movement, a crystal, a hand, an applique, a logo, a disk or an oscillating mass.

Another aspect of the invention relates to a method for decorating the external part component of a watch case as described above, consisting of exposing the stack of thin layers to light rays on a predefined exposure zone, so as to locally change the phase of the phase switching layer, and hence the refractive index thereof, and hence furthermore the interferential colour of the stack in said exposure zone, and thus generating a two-tone pattern on said external part component.

Thus it is possible to produce a two-tone decoration on the external part component of the watch case when the latter is assembled, and therefore to customise the decoration of the external part component at any stage of the lifetime of said watch case.

In implementations of the invention, the light rays are generated by a laser beam controlled by a control unit, so as to control the localised temperature rise of the phase switching layer, the exposure time and the shape of the predefined exposure zone.

Thanks to this feature, the patterns can be generated very precisely, so as to allow a very great diversity of decorations that can be envisaged and enable a high production quality of these decorations.

### BRIEF DESCRIPTION OF THE FIGURES

Further features and advantages of the invention will emerge on reading the following detailed description given by way of non-limiting example, with reference to the appended drawings wherein:

FIG. 1 schematically represents a sectional view of a watch case according to the present invention;

FIG. 2 schematically represents a sectional view of an external part component of the watch case in FIG. 1;

FIG. 3 schematically represents a sectional view of an external part component of the watch case in FIG. 1 wherein the external part component forms a support forming the encapsulation layer;

FIG. 4 schematically represents a sectional view of an external part component of the watch case in FIG. 1 wherein the support forms a substrate layer;

FIG. 5 schematically represents a sectional view of an external part component of the watch case in FIG. 4 according to a further example of embodiment of the invention wherein the substrate layer is transparent;

FIG. 6 schematically represents a sectional view of an external part component of the watch case in FIG. 3 according to a further example of embodiment of the invention wherein the substrate layer is transparent.

### DETAILED DESCRIPTION OF THE INVENTION

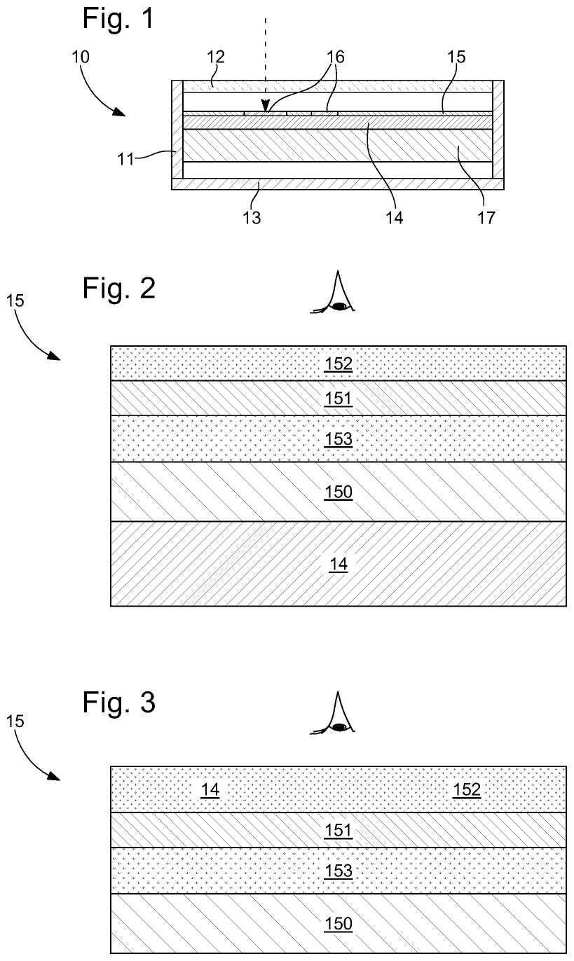

FIG. 1 shows a schematic representation of a sectional view of a watch case 10 according to the present invention. The watch case 10 includes a middle 11 to which a crystal 12 and a back 13 are fastened so as to form an internal volume.

The watch case 10 includes, in said internal volume, an external part component 14 whereon a stack of thin layers 15 is deposited. In other words, the stack of thin layers 15 forms a coating of the external part component 14.

The stack of thin layers 15 is configured so as to impart to the external part component 14, on a surface thereof intended to be visible for a user, several predetermined interferential colours as described in more detail hereinafter.

Advantageously, the external part component 14 can be formed by a dial, as seen in FIG. 1, by a structure of a horological movement 17, for example a bar or a plate, by an oscillating mass, a flange, or by any other component housed in the internal volume of the watch case 10 or on said watch case 10, such as the back 13, the crystal 12, a bezel, etc.

It is worth noting that, herein, the term crystal is used hereinafter to refer to the crystal 12 or any crystal of the back 13.

The stack of thin layers 15 includes a substrate layer 150, a solid-state phase switching layer 151 inserted between a transparent encapsulation layer 152 and a spacing layer 153 separating said phase switching layer 151 from the substrate layer 150.

It is worth noting that the term “transparent” refers herein to a capability of a material to allow all or part of a light radiation, particularly light visible to the naked eye, to pass through.

The interferential colours are generated by an interference effect produced by the arrangement of the encapsulation layer 152, the phase switching layer 151, the spacing layer 153 and the substrate layer 150, in a reflective or transmissive manner according to the example of embodiment of the present invention in question.

In the example of embodiment of the invention represented in FIG. 2, the stack of thin layers 15 can be deposited on a support, made of any suitable material, said support being formed by all or part of the external part component 14. In other words, the substrate layer 150 is arranged against the support and separates the spacing layer 153 from the support.

For example, the support can be made of metallic material, silicon with native oxide, glass, quartz, sapphire, polyethylene terephthalate, for example in the form of a film.

In the embodiment example represented in FIG. 2, the substrate layer 150 can be formed by a reflective layer, for example produced by a metallic mirror, preferably made of a material having a high reflection factor, for example platinum, rhodium, silver, aluminium, etc. This layer can have a thickness, defined here as being the dimension along the direction wherein the thin layers are overlaid on one another, of about 100 nm.

The spacing layer 153 is made of transparent dielectric material. Such a material can be indium tin oxide, silicon dioxide or zinc sulphide. Preferably, the spacing layer 153 has a thickness between 50 nm and 200 nm.

The phase switching layer 151 has the capability, due to the constituent material thereof, to change from a crystalline or amorphous phase to a respectively amorphous or crystalline phase, under exposure from adapted light rays.

Such light rays are represented in FIG. 1 by the dashed arrow.

In particular, the phase switching layer 151 is configured to have two switchable phase states, preferably in a reversible manner. In other words, the phase switching layer 151 is configured to be able to change, following the exposure to light rays, from an initial crystalline or amorphous phase to a final respectively amorphous or crystalline phase, and return to the initial phase thereof.

More specifically, the exposure of the stack of thin layers 15 to the light rays locally generates a localised temperature rise of the phase switching layer 151. A temperature located above the vitreous transition point applied for a relatively long time, for example several seconds or tens of seconds, induces a crystallisation of the phase switching layer 151, i.e. a change from the amorphous phase to the crystalline phase, and a temperature located above the melting point applied for a sufficiently short time to fix the amorphous phase without recrystallisation induces an amorphisation of the phase switching layer 151, i.e. a change from the crystalline phase to the amorphous phase.

By way of preferential example, the phase switching layer 151 has an amorphous phase after having been deposited, such that the initial phase is the amorphous phase.

The phase switching layer 151 does not have the same refractive index depending on whether it has a crystalline phase or an amorphous phase. Thus, the change of phase of the phase switching layer 151 varies the refractive index thereof, and therefore the perception of the visual appearance thereof for a user insofar as the interferential colour of the stack is dependent on the refractive index of the phase switching layer 151.

In other words, the phase switching layer 151 is configured such that the refractive index thereof has either of two values following the exposure to the light rays. It is worth noting that the light rays are generated so as to locally impact the stack of thin layers 15 via the encapsulation layer 152 such that the external part component has two different interferential colours.

Advantageously, the phase switching layer 151 is made of phase-change material such as of Ge2Sb2Te5 or AgInSbTe. Preferably, the phase switching layer 151 has a thickness between 5 nm and 20 nm.

In a method for decorating the external part component 14, the light rays are applied locally on a predefined exposure zone 16 on the surface of the stack of thin layers 15, so as to generate a predetermined pattern on the external part component 14. Such a pattern therefore has a different interferential colour from that of the rest of the external part component and can be in the form of a logo, a text or any other graphic representation.

In other words, a portion of the phase switching layer 151 has an amorphous or crystalline phase, the rest of said layer having a different phase, and thus a different refractive index, which enables the generation of two different interferential colours.

The light rays are generated preferably by a laser beam controlled by a control unit known per se to a person skilled in the art, so as to control at least the localised temperature rise of the phase switching layer 151, the exposure time and the shape of the predefined exposure zone 16 on the surface of the stack of thin layers 15.

Preferably, the laser beam emits light rays in which the wavelength is in the infrared range, the invention can also be implemented with lasers in which the beam emits light rays in which the wavelength is within the visible range or the ultraviolet range. The working power of the laser is relatively low, preferably around 50 mW with a pulse duration of the order of 5 ms, i.e. a pulse energy of the order of 250 μJ, in order to switch the phase of the phase switching layer 151 without any risk of damaging it by effects of overheating, ablation, etc.

The encapsulation layer 152 makes it possible to protect the stack of thin layers 15 and in particular the phase switching layer 151 against oxygen and moisture in particular. It is through this encapsulation layer 152 that the phase switching layer 151 is visible for a user.

Moreover, the encapsulation layer 152 is transparent at the wavelength of the light rays to which the phase switching layer 151 is exposed.

The encapsulation layer 152 can be particularly made of indium tin oxide, silicon dioxide or zinc sulphide.

The thickness and the material of the encapsulation layer 152 and the spacing layer 153 are chosen according to the desired colour of the stack of thin layers 15. Indeed, the thickness and the material of the encapsulation 152 and spacing 153 layers vary the respective refractive index thereof, and hence, the interferential colour.

Preferably, the encapsulation layer 152 has a thickness of about 10 nm.

The stack of thin layers 15 has advantageously a very small thickness and hence can be applied on the external part component 14 of the watch case 10 without modifying the design of said watch case 10 or said external part component 14.

Advantageously, in a further example of embodiment of the present invention represented in FIG. 3, the encapsulation layer 152 can be formed by the support, which is then made of transparent material.

The stack of thin layers 15 is then viewed, by a user, via the support.

The external part component 14 is in this case formed by a crystal or by a dial made of a transparent material. Advantageously, the stack of thin layers 15 is thus located in the internal volume of the watch case 10 and is not exposed to any friction.

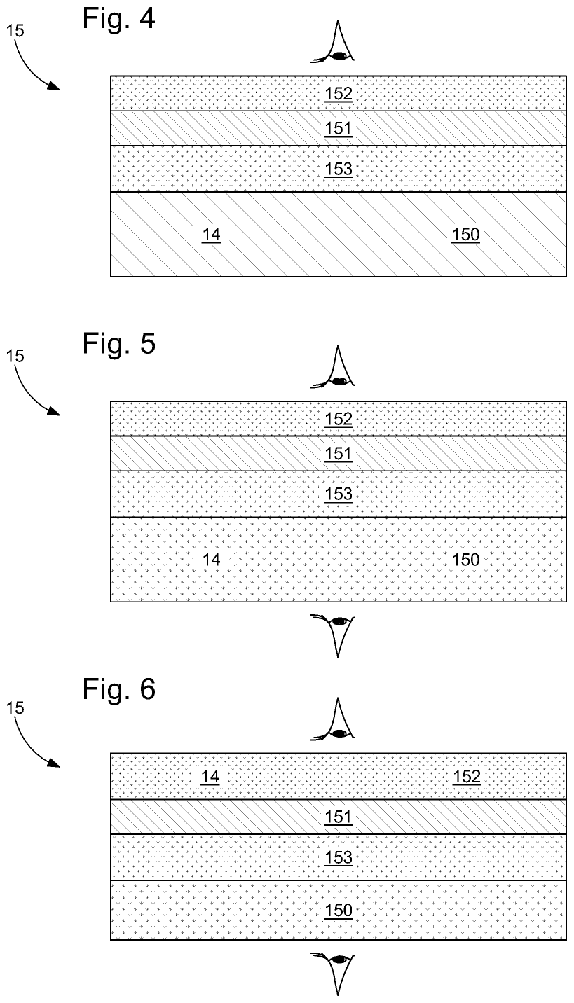

Advantageously, in a further example of embodiment of the present invention represented in FIG. 4, the substrate layer 150 can be formed by the support, i.e. by the external part component 14, which is then made of reflective material, for example of platinum, rhodium, silver, aluminium, etc.

In the examples of embodiment of the present invention represented in FIGS. 2 and 3, as the substrate layer 150 is formed by a reflective layer, the stack of thin layers 15 is likely to reflect the light to which it is exposed, and to generate an aesthetic appearance of opaque plain interferential colours.

In further examples of embodiment of the invention, represented in FIGS. 5 and 6 respectively, the substrate 150 is not formed by a reflective layer, unlike the embodiment examples described above and illustrated in FIGS. 2 to 4, but is transparent or translucent. More specifically, the substrate layer 150 is formed by a transparent or translucent material, such as polyethylene terephthalate, glass, sapphire, etc.

More specifically, in the example of embodiment of the invention seen in FIG. 5, the substrate layer 150 is formed by the support, and in the embodiment example seen in FIG. 6, the encapsulation layer 152 is formed by the support.

In these examples of embodiment of the invention, the interference effect produced by the arrangement of the phase switching layer 151, the spacing layer 153 and the substrate layer 150, is of transmissive type.

In the embodiment examples represented in FIGS. 5 and 6, the decoration generated by the stack of thin layers 15 can be observed by the user both through the encapsulation layer 152 and through the substrate layer 150.

In these examples of embodiment of the invention, the external part component 14 can advantageously consist of a crystal or a dial.

More generally, it should be noted that the implementations and embodiments considered above have been described by way of non-limiting examples and that further variants can consequently be envisaged.

As a general rule, the different thin layers of the stack of thin layers 15 can be deposited by a cathode sputtering method, or by another suitable deposition method.

1. A watch case (10) comprising a middle (11) to which a crystal (12) and a back (13) are fastened so as to form an internal volume, said watch case (10) including, in said internal volume, an external part component (14) whereon a stack of thin layers (15) comprising a substrate layer (150), a solid-state phase switching layer (151) inserted between a transparent encapsulation layer (152) and a spacing layer (153) separating said phase switching layer (151) from the substrate layer (150) is deposited, the phase switching layer (151) being configured so as to have a refractive index capable of varying under exposure from light rays so as to impart to the stack of thin layers (15) at least two interferential colours,
wherein the substrate layer (150) is made of transparent or translucent material and
wherein the stack of thin layers (15) is deposited on a support formed by all or part of the external part component (14), the substrate layer (150) or the encapsulation layer (152) being formed by the support.

2. The watch case (10) according to claim 1, wherein the phase switching layer (151) is configured to have two reversibly switchable phase states, said phase states being a crystalline phase and an amorphous phase.

3. The watch case (10) according to claim 1, wherein the encapsulation layer (152) is transparent at the wavelength of the light rays under the exposure whereof the refractive index of the phase switching layer (151) is capable of varying.

4. The watch case (10) according to claim 1, wherein the external part component (14) is a dial, a structure of a horological movement (17), a crystal, a display, a hand, an applique, a logo or an oscillating mass.

5. A method for decorating the external part component (14) of a watch case (10) according to claim 1, comprising exposing the stack of thin layers (15) to light rays, on a predefined exposure zone (16), so as to locally change the phase of the phase switching layer (151) and to generate a pattern on said external part component (14).

6. The decoration method according to claim 5, wherein the light rays are generated by a laser beam controlled by a control unit, so as to control the localised temperature rise of the phase switching layer (151), the exposure time and the shape of the predefine exposure zone (16).
